(19) United States
(12) Patent Application Publication
(10) Pub. No.: US 2010/0037020 A1
(43) Pub. Date: Feb. 11, 2010

(54) PIPELINED MEMORY ACCESS METHOD AND ARCHITECTURE THEREFORE

(75) Inventors: Hai Li, Eden Prairie, MN (US); Yiran Chen, Eden Prairie, MN (US); Hongyue Liu, Maple Grove, MN (US); Dadi Setiadi, Edina, MN (US); Brian Lee, Eden Prairie, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/200,118

(22) Filed: Aug. 28, 2008

Related U.S. Application Data
(60) Provisional application No. 61/086,867, filed on Aug. 7, 2008.

(51) Int. Cl. G06F 12/00

(52) U.S. Cl. 711/114; 711/E12.001

(57) ABSTRACT

A memory array and a method for accessing a memory array including: receiving an address from a host related to relevant data; accessing a first module based on the address received from the host, wherein accessing the first module includes: decoding the address for the first module; enabling a wordline based on the decoded address for the first module and sensing the contents of one or more bits at the decoded address for the first module; and outputting information regarding the first module; and accessing a second module based on the address received from the host, wherein accessing the second module includes: decoding the address for the second module; enabling a wordline based on the decoded address for the second module and sensing the contents of one or more bits at the decoded address for the second module; and outputting information regarding the second module, wherein the step of decoding the address for the second module occurs while the step of enabling a wordline based on the decoded address for the first module and sensing the contents of one or more bits at the decoded address for the first module occurs.

### PRIORITY

This application claims priority to previously filed U.S. Provisional Application Ser. No. 61/086867, entitled “PIPELINED NON-VOLATILE MEMORY ARCHITECTURE”, filed on Aug. 7, 2008, the disclosure of which is incorporated herein by reference.

### BACKGROUND

As technology advances and performance of computer processors improve memory systems must be able to be accessed at increasingly higher bandwidths. Furthermore, some memory technologies suffer even greater bandwidth constraints because of the different ways in which they operate. Therefore, improving the bandwidth of memory has become and will remain a focus of memory design.

Therefore, new ways to access memory that provide advantageous bandwidth without requiring significantly more power and substantial overhead remain desirable.

### BRIEF SUMMARY

Disclosed herein is a method for accessing a memory array, the memory array including at least two modules, the method including: receiving an address from a host related to relevant data; accessing a first module based on the address received from the host, wherein accessing the first module includes: decoding the address for the first module; enabling a wordline based on the decoded address for the first module and sensing the contents of one or more bits at the decoded address for the first module; and outputting information regarding the first module; and accessing a second module based on the address received from the host, wherein accessing the second module includes: decoding the address for the second module; enabling a wordline based on the decoded address for the second module and sensing the contents of one or more bits at the decoded address for the second module; and outputting information regarding the second module, wherein the step of decoding the address for the second module occurs while the step of enabling a wordline based on the decoded address for the first module and sensing the contents of one or more bits at the decoded address for the first module occurs.

Also disclosed herein is a method for accessing a memory array, the memory array including at least two modules, the method including: receiving an address from a host related to relevant data; accessing a first module based on the address received from the host, wherein accessing the first module includes: decoding the address for the first module; enabling a wordline based on the decoded address for the first module and sensing the contents of one or more bits at the decoded address for the first module; and outputting information regarding the first module; and accessing a second module based on the address received from the host, wherein accessing the second module includes: decoding the address for the second module; enabling a wordline based on the decoded address for the second module and sensing the contents of one or more bits at the decoded address for the second module; and outputting information regarding the second module, wherein the step of decoding the address for the second module occurs while the step of enabling a wordline based on the decoded address for the first module and sensing the contents of one or more bits at the decoded address for the first module occurs, and wherein the number of modules within the memory array and the size of each module are chosen so that the time spent on the decoding step, the enabling and sensing step, and the outputting step are all substantially equal.

Also disclosed herein is a memory array that includes a first memory module, the first memory module containing at least one row of data having at least one bit of data; a first latch configured to control initiation of wordline enablement and data sensing from at least the first memory module; and a second latch configured to control completion of wordline enablement and data sensing from at least the first memory module.

### BRIEF DESCRIPTION OF THE DRAWINGS

The disclosure may be more completely understood in consideration of the following detailed description of various embodiments of the disclosure in connection with the accompanying drawings, in which:

FIGS. 1a and 1b are flow diagrams of embodiments of methods as disclosed herein utilizing two memory modules and sub-steps that may be involved;

FIG. 2 is an illustration of an embodiment of a memory array as disclosed herein;

FIG. 3 is a timing diagram of an embodiment of a method as disclosed herein utilizing two memory modules;

FIG. 4 is a flow diagram of an exemplary embodiment of a method as disclosed herein utilizing three memory modules;

FIGS. 5a and 5b are timing diagrams of embodiments of methods as disclosed herein utilizing three memory modules;

FIG. 6 is a circuit diagram of an embodiment of a memory array including a first and second latch;

FIG. 7 is a circuit diagram of an embodiment of a memory array as disclosed herein including sub-arrays and associated circuitry;

FIG. 8 is an illustration of an exemplary embodiment of a memory array as disclosed herein implemented as a three-dimensional stack;

FIG. 9 is an illustration of a distributed RC model of interconnect; and

FIGS. 10a and 10b are illustrations depicting improvement that may be realized in the three-dimensional stack of FIG. 8.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Disclosed herein is a method of accessing a memory array and memory arrays. The memory array discussed herein can include any type of memory. Exemplary types of memory that can be utilized include, but are not limited to, non-volatile memory. Non-volatile memory includes any kind of computer memory that can retain information stored thereon when not powered. Any known types of non-volatile memory may be used as the non-volatile main memory. Examples of non-volatile memory that may be utilized as the non-volatile main memory include, but are not limited to, read only memory (ROM), flash memory, hard drives, and random access memory (RAM). Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RAM (NRAM), spin torque transfer RAM (STTRAM) which is also referred to as STRAM; and Silicon-Oxide-Nitride-Oxide-Silicon (SONOS), which is similar to flash RAM. Solid-state drives, which are similar in functioning to hard drives an also be utilized as non-volatile memory.

Memory arrays as disclosed and utilized herein generally include at least one memory module. A memory module is generally a portion of a memory array. Some embodiments of memory arrays include more than one memory module. Some embodiments include at least two memory modules; some embodiments include at least three memory modules; and some embodiments include a plurality of memory modules. Some embodiments of memory arrays can also include a sub-array that includes one or more than one memory modules.

In an embodiment, a memory array can increase its storage capacity by increasing the number of memory modules, increasing the capacity of each individual memory module, or both. Different types of memory, different applications of the memory array, or a combination thereof may dictate, at least in part, which method of increasing memory capacity may be more advantageous.

Each memory module within a memory array includes at least one row of data, with the at least one row of data including at least one bit of data. In an embodiment, each memory module will include two or more rows of data and in another embodiment, each memory module will include a plurality of rows of data. In an embodiment, each row of data within each memory module will include two or more bits of data and in another embodiment, each row of data within each memory module will include a plurality of bits of data. Each bit of data within a memory module has a unique address associated therewith. Methods and schemes of addressing bits within memory systems are known, and any such method for addressing bits can be utilized with memory arrays and methods of accessing memory arrays disclosed herein.

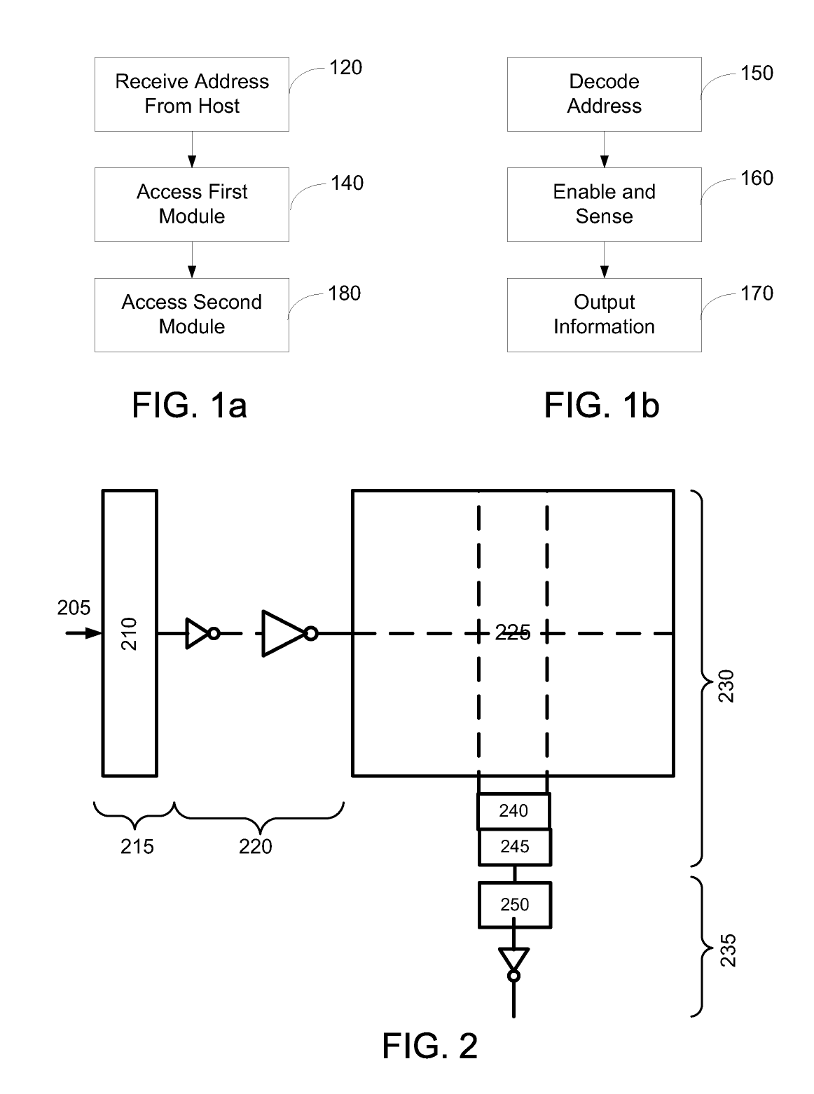

An exemplary method of accessing memory arrays as disclosed herein is depicted in FIG. 1a and includes the steps of receiving an address from a host, depicted as step 120; accessing a first module based on the address received from the host, depicted as step 140; and accessing a second module based on the address received from the host, depicted as step 180. Exemplary methods as disclosed herein can also include other steps before, after or between the steps depicted in FIG. 1a.

The step of receiving an address from a host, depicted in FIG. 1a as step 120 generally functions to allow a host to communicate with the memory array regarding data. The term host as used herein refers to a processor or a system interface of a system that can interact with the memory array. The interaction of the host with the memory array can include issuing read and/or write commands to the memory array. The system may be a general purpose computer system such as a PC (e.g., a notebook computer; a desktop computer), a server, or it may be a dedicated machine. The communication can include a read command or a write command. Generally, a read command is a command from a host that requests data from a memory array; and a write command is a command from a host that requests that data be written to a memory array.

All interactions of the host with the memory array include receipt of an address from the host. The address can provide an indication of the particular bit or bits within a row within a memory module that are of interest to the host.

Methods as disclosed herein also include a step of accessing a first memory module based on the address received from the host, which is depicted as step 140 in FIG. 1a. Methods as disclosed herein may also include steps of accessing subsequent memory modules based on the address received from the host, such as for example, accessing a second memory module based on the address received from the host, which is depicted as step 180 in FIG. 1a. Further memory modules may also be accessed in methods as disclosed herein. Generally utilized structures and protocols for accessing memory modules can be utilized.

FIG. 1b illustrates exemplary steps involved in accessing a memory module (a first memory module, a second memory module, or an nth memory module); or stated another way, FIG. 1b illustrates exemplary steps that may be involved in the step 140 (or step 180 for example) for accessing the first memory module. FIG. 1b illustrates the steps of decoding the address for the memory module, which is depicted as step 150; enabling a wordline and a bit line based on the decoded address and sensing the contents of the data contained at the decoded address, which is depicted as step 160; and outputting relevant information, which is depicted as step 170.

The function of these three exemplary steps will be further explained in the context of an exemplary memory module. It should be noted that the particular memory module exemplified herein is an example only and is in no way intended to limit the scope of this disclosure. An exemplary memory array includes four memory modules; each memory module includes 4,096 bits so that the entire memory array includes 16,384 bits of memory. Each memory module is organized into 128 word lines that include 32 bits of data each. Once a host supplies an address, the address is decoded (step 150 in FIG. 1b). Decoding the address generally includes applying two addresses (one referring to the particular word line and one referring to the particular bit line) to a decoder in order to calculate an effective address of the data bits to be fetched from the memory module. The address, once decoded determines which wordline and bit line in the memory module is to be accessed. Step 150 is sometimes referred to herein as simply “decoding”.

The next step then is to enable the particular wordline based on the decoded address and sense the contents of the data contained at the particular bit or bits, step 160 in FIG. 1b. In some types of memory, enabling the word line generally includes raising the wordline to a high voltage. Specifics of sensing the contents of the particular bit depend on what kind of memory makes up the memory array. The time required to carry out the step of enabling the wordline and sensing the contents of the particular bit can depend at least in part on the type of memory making up the memory module, the size of the memory module, and the particular configuration of the memory module. Step 160 is sometimes referred to herein as simply “enabling and sensing”.

Once the contents of the bit have been sensed, the next step is to output information from the memory module, which is depicted as step 170 in FIG. 1b. Information that could be output from the memory module include, but is not limited to, indication of a “hit”, indication of a “miss”, or indication of an error. A “hit” occurs when the data being sought by the host is found within the memory module. In such a case, the information that could be output from the memory module is the data being sought (in the case of a read command); or an indication that the data was written to the memory module (in the case of a write command). A “miss” occurs when the data being sought by the host is not found within the memory module. In such a case, information indicating a “miss” could be sent out from the memory module. If a “miss” occurs, a subsequent memory module can be accessed and steps, such as those depicted in FIG. 1b can be carried out on a second or subsequent memory module. An indication of an error could be sent out if the data within the bit or bits cannot be sensed. Step 170 is sometimes referred to herein simply as “outputting”.

FIG. 2 illustrates steps such as those depicted in FIG. 1a being carried out on an exemplary memory module 225. Arrow 205 depicts the step of receiving an address from a host. The address can generally be received by a decoder, which is depicted as decoder 210. The time that it takes the decoder 210 to decode the address for a module, or stated another way, to determine the particular wordline and bit line that is to be accessed based on the address received can sometimes be referred to as the decoding delay 215.

Once the decoder 210 has determined the particular wordline that is to be accessed, the next step is to actually access that wordline. In order to access a particular wordline, it must first be enabled. A wordline is enabled, in some instances, by raising the wordline to a high voltage. Some types of memory use different actions to enable a wordline, the present disclosure also encompasses such other methods of enabling a wordline. The time it takes to enable a wordline is often referred to as the wordline delay 220.

After the wordline has been enabled, the contents of one or more bits are sensed and the contents can be amplified. Amplification of the contents is optional, and need not occur, for example, a signal can be amplified if it is too weak. Generally, this can include detecting the contents of the bit using one or more sense amplifiers. The time it takes to sense the contents of one or more bits at a particular address is sometimes referred to as the bit line and sense amplifier delay 230. In an embodiment, the bit line and sense amplifier delay 230 involves a multiplexer 240; and a sense amplifier 245.

After the contents of one or more bits have been sensed, the next step includes outputting information regarding the module, in this case memory module 225. Generally, this includes propagating the information through an input/output circuit. The time it takes to output the information regarding the module is sometimes referred to as the data out delay 235. In an embodiment, the data out delay 235 involves a multiplexer 250.

In embodiments of this disclosure, some of the steps involved in accessing a memory module can be overlapped with other steps. Such overlap of different portions of a single memory access can reduce the clock cycle of a single memory access, which can allow more data to be accessed in the same time period. The particular steps that can be overlapped depend on the mechanics of the step, the actions that make up that step, the structures on which the steps are being carried out, or some combination thereof. In an embodiment, the enabling and sensing step utilizes a signal on the bit line that is a weak analog signal. For this reason, only one enabling and sensing step can be carried out at one time. The present disclosure utilizes the ability to carry out other steps of an access at the same time as the enabling and sensing step.

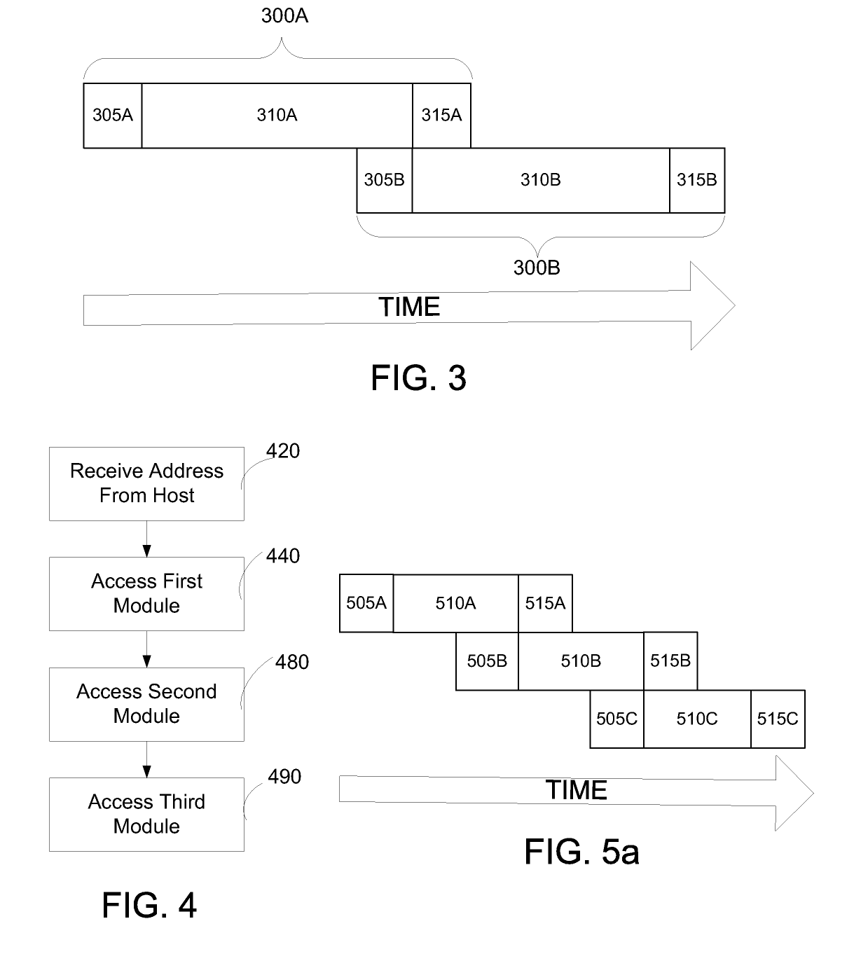

For example, enabling a wordline based on the decoded address for a first module and sensing the contents of one or more bits at the decoded address for that module cannot be carried out at the same time as enabling a wordline based on the decoded address for a second module and sensing the contents of one or more bits at the decoded address for the second module. In an embodiment, where at least two memory modules are accessed with regard to the same address from the host, the step of decoding the address for the second module can occur at the same time as the step of enabling a wordline based on the decoded address for the first module; but the step of enabling a wordline based on the decoded address for the second module cannot begin until the step of enabling a wordline based on the decoded address for the first module has been completed. Such a scenario is schematically depicted in FIG. 3.

FIG. 3 depicts a portion of a method as disclosed herein. Once an address is received from a host (not shown in FIG. 3), a first module is accessed, depicted as 300A, and then a second module is accessed, depicted as 300B. The access of the first module 300A includes decoding the address for the first module 305A, enabling a wordline and sensing the contents of one or more bits 310A and outputting information regarding the first module 315A. Similarly, the access of the second module 300B includes decoding the address for the second module 305B, enabling a wordline and sensing the contents of one or more bits 310B and outputting information regarding the second module 315B. The steps of each access are indicated in time with respect to time increasing from left to right (as shown by the arrow).

As seen in FIG. 3, the first thing that happens, is step 305A, the address for the first module is decoded. This is followed by step 310A, enabling a wordline and sensing the contents of one or more bits. Step 305B, decoding the address for the second module can begin while the step of enabling and sensing 310A is still occurring. However, the step of enabling a word line and sensing the contents of one or more bits in the second module 310B cannot begin until after the step of enabling a word line and sensing the contents of one or more bits in the first module 310A is complete. The step of outputting information regarding the first module 315A can then be occurring during the step of enabling a wordline and sensing the contents of one or more bits in the second module 310B. Such a scenario does not include two different enabling and sensing steps happening simultaneously. This scenario could cause the signal to be lost because the signal is a weak analog signal.

FIG. 4 illustrates another exemplary embodiment of a method as disclosed herein. FIG. 4 illustrates a method that includes receiving an address from a host, depicted as step 420; accessing a first module based on the address received from the host, depicted as step 440; accessing a second module based on the address received from the host, depicted as step 480; and accessing a third module based on the address received from the host, depicted as step 490. Exemplary methods as disclosed herein can also include other steps before, after or in between the steps depicted in FIG. 4. Methods as disclosed herein can include accessing all memory modules included in a memory array, or less than all memory modules included in a memory array. The step of accessing the third memory module based on the address received from the host can include steps as previously discussed above, such as: decoding the address for the third module; enabling a wordline based on the decoded address for the third module and sensing the contents of one or more bits at the decoded address for the third module; and outputting information regarding the third module.

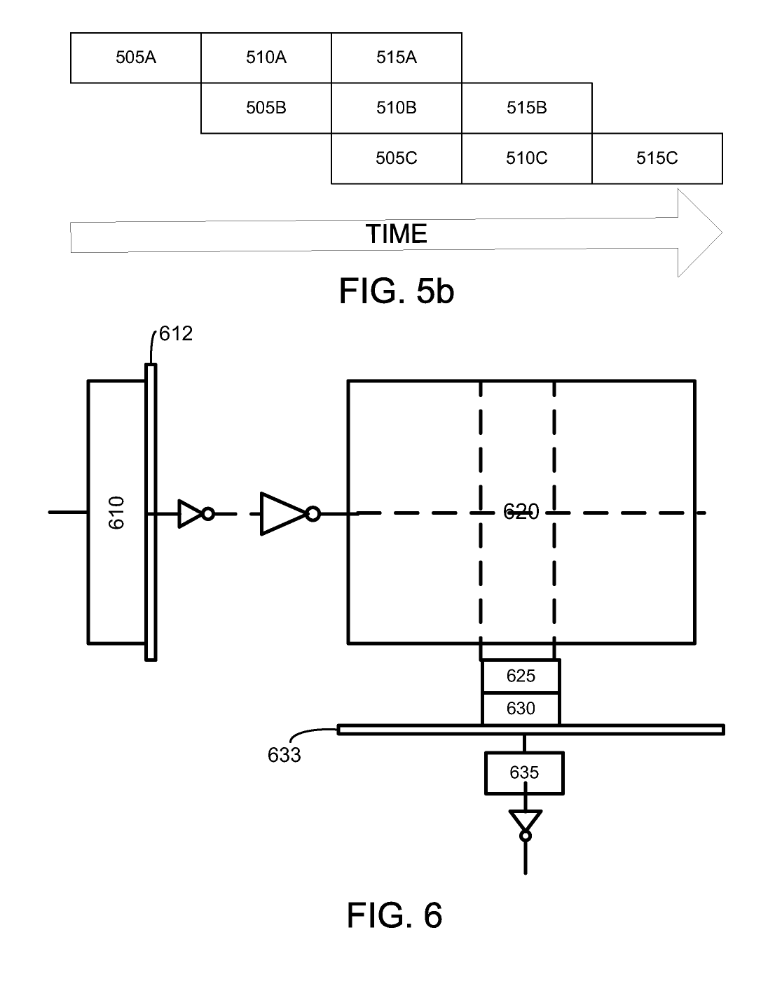

FIG. 5a illustrates the timing of a method that includes accessing at least three memory modules. The steps involved in accessing the first memory module are represented as decoding the address for the first module 505A, enabling and sensing from the first module 510A and outputting information regarding the first module 515A. The steps involved in accessing the second memory module are represented as decoding the address for the second module 505B, enabling and sensing from the second module 510B and outputting information regarding the second module 515B. The steps involved in accessing the third memory module are represented as decoding the address for the third module 505C, enabling and sensing from the third module 510C and outputting information regarding the third module 515C. As seen in FIG. 5, no two enabling and sensing steps are carried out at the same time; see the timing of steps 510A, 510B and 510C. Also note in FIG. 5a that in an embodiment, the step of outputting information regarding the first module 515A; the step of enabling a wordline based on the decoded address for the second module and sensing the contents of one or more bits at the decoded address for the second module 510B; and the step of decoding the address for the third module 505C can overlap somewhat or entirely.

Assuming that the length of the various steps (along the time scale) in FIG. 5a are indicative of the time that these steps take, it can be seen that the step of enabling a wordline and sensing the contents of one or more bits can take more time, i.e. cause a longer delay than the other steps involved in accessing a single module. This is often the case because a bit line can have a very heavy load which includes the capacitance of multiple memory cells and the wire capacitance and resistance of a bit line. This can create an uneven split in timing between the three discrete steps. From a comparison of FIG. 3 and FIG. 5a, the unevenness is seen to decrease, but not be equalized. Such an uneven split can inherently limit the minimum clock cycle that can be obtained for accessing a single memory module. Minimizing the clock cycle of a single access would presumably provide an advantage of making the entire access of a memory array quicker.

Certain types of memory may have an even larger relative delay for the step of enabling and sensing. For example, in MRAM design, the current that is used to sense the data in the bit line must be limited because currents that are too high can flip the state of the cell, causing the data to be changed. Because the current is lower, the bit line delay is even longer. Also, the transistor within a MRAM cell has to have a relatively large size in order to enable fast write operations. Both of these factors can make the wordline delay for MRAM even longer. Because of this, a memory array that includes MRAM could greatly benefit if the time for the discrete steps were equalized.

FIG. 5b illustrates the timing of an exemplary method as disclosed herein that includes accessing at least three memory modules. The steps of the methods in FIG. 5b are the same as those depicted in FIG. 5a. As seen in FIG. 5b, the relative times of the various steps have changed in comparison to the times of the steps in FIG. 5a. The method and timing thereof depicted in FIG. 5b therefore shows a method where the step of enabling and sensing for the first memory module, 510A, does not happen at the same time as the step of enabling and sensing for the second module, 510B; and the step of enabling and sensing for the second module, 510B, does not happen at the same time as the step of enabling and sensing for the third module, 510C. Stated another way, although there are three enabling and sensing steps, none of the three steps occur at the same time. Also in such an embodiment, it can be seen that the step of outputting from the first module, 515A; the step of enabling and sensing for the second module, 510B; and the step of decoding for the third module, 505C can all happen simultaneously.

The difference in the memory array and the timing of accessing the memory array that is exemplified by a comparison of FIGS. 5a and 5b can offer advantages. An embodiment such as that depicted in FIG. 5b can offer advantages because three operations can occur simultaneously; and the total clock cycle is therefore smaller than if a method of this disclosure were not utilized. Memory arrays and methods of accessing memory arrays can be configured such that desired total memory capacity is obtained but decoding delay, enabling and sensing delay and output delay are substantially equalized. Such a configuration can offer advantages of increased memory capacity while still maintaining access speed. In an embodiment, the number of memory modules within a memory array and the size of each memory module is chosen so that the time it takes to decode the address for a module; enable and sense for a memory module; and output for the memory module are substantially equal.

Such methods can further include optional steps which can occur before, after, in combination with, or at any point in between the steps that were previously discussed. In an embodiment, a step of decoding an address for a memory module further includes selecting among at least two memory modules. In an embodiment, a step of outputting information regarding two or more modules further includes correlating data sensed from the two or more memory modules.

Also disclosed herein are memory arrays. An exemplary memory array includes a first memory module, the first memory module containing at least one row of data having at least one bit of data; a first latch configured to control initiation of wordline enablement and data sensing from at least the first and second memory modules; and a second latch configured to control completion of wordline enablement and data sensing from at least the first memory module. The memory array or more specifically the at least first memory module can include volatile or non-volatile memory as discussed above. In an embodiment, the memory array, or more specifically the at least first memory module can include non-volatile memory. In an embodiment, the memory array, or more specifically, the at least first memory module can include MRAM, RRAM, PCM, STTRAM or PMC. In an embodiment, the memory array, or more specifically, the at least first memory module can include MRAM. Memory arrays as disclosed herein can also include at least a second memory module. Memory arrays as disclosed herein can also include a plurality of memory modules.

Memory arrays as disclosed herein also include a first latch. The first latch is generally configured to control initiation of wordline enablement and data sensing from at least the first memory module. The first latch generally functions to separate the step of decoding from the step of enabling and sensing. The first latch can also function to control, monitor or both control and monitor initiation of enabling and sensing steps. Controlling or monitoring initiation of enabling and sensing steps is relevant to methods disclosed herein because as discussed above, only one enabling and sensing step can occur at any one time.

Memory arrays as disclosed herein also include a second latch configured to control completion of wordline enablement and data sensing from at least the first memory module. The second latch generally functions to separate the step of enabling and sensing from the step of outputting information. The second latch can also function to control, monitor or both control and monitor completion of enabling and sensing steps. Controlling or monitoring initiation of enabling and sensing steps is relevant to methods disclosed herein because as discussed above, only one enabling and sensing step can occur at any one time.

FIG. 6 illustrates a memory array as disclosed herein. The memory array illustrated in FIG. 6 is illustrated in combination with the steps of accessing the memory array. The exemplary memory array illustrated in FIG. 6 shows a first memory module 620, a decoder 610, a first latch 612 and a second latch 633. As illustrated in FIG. 6, the first latch 612 is configured within the memory array so that it controls, monitors, or both controls and monitors the initiation of the enabling and sensing; or stated another way, the first latch controls, monitors, or both controls and monitors the completion of decoding by the decoder 610. The second latch 633 is configured within the memory array so that it controls, monitors, or both controls and monitors the completion of the enabling and sensing; or stated another way, the second latch controls, monitors, or both controls and monitors the initiation of outputting information from the output multiplexer 635. The memory array depicted in FIG. 6 also includes a column multiplexer 625 and a sense amplifier 630.

Advantages as discussed herein can be, but need not be, further enhanced by adding another layer of organization into the memory array. For example, a memory array can include one or more sub-arrays with each sub-array including one or more memory modules. In order to compensate for relatively longer enabling and sensing delays, which can be even longer in some types of memory arrays, it can be advantageous to divide the memory array into more, but smaller sub arrays that each include one or more memory modules. In such an embodiment, each of the memory modules will have fewer rows, fewer bits, or both fewer rows and fewer bits. A memory module that has fewer rows will have a correspondingly smaller bit line delay. Also, because the addressing scheme can be simplified, a memory module with fewer rows can utilize a less complex decoder. Some systems utilizing a less complex decoder (because of fewer rows) may however need to be pre-decoded to indicate which module to access. This could cause the decoding delay to be increased, therefore making the decoding delay closer to the enabling and sensing delay. A memory module that has fewer columns will have a correspondingly smaller wordline delay. However, a bank multiplexer may be added in order to select the requested output from the multiple modules. This could case the output delay to be increased, therefore making the output delay closer the enabling and sensing delay. As seen from this discussion, creation of another layer, i.e. a sub-array, is one way of equalizing the delay from the three steps of a single access.

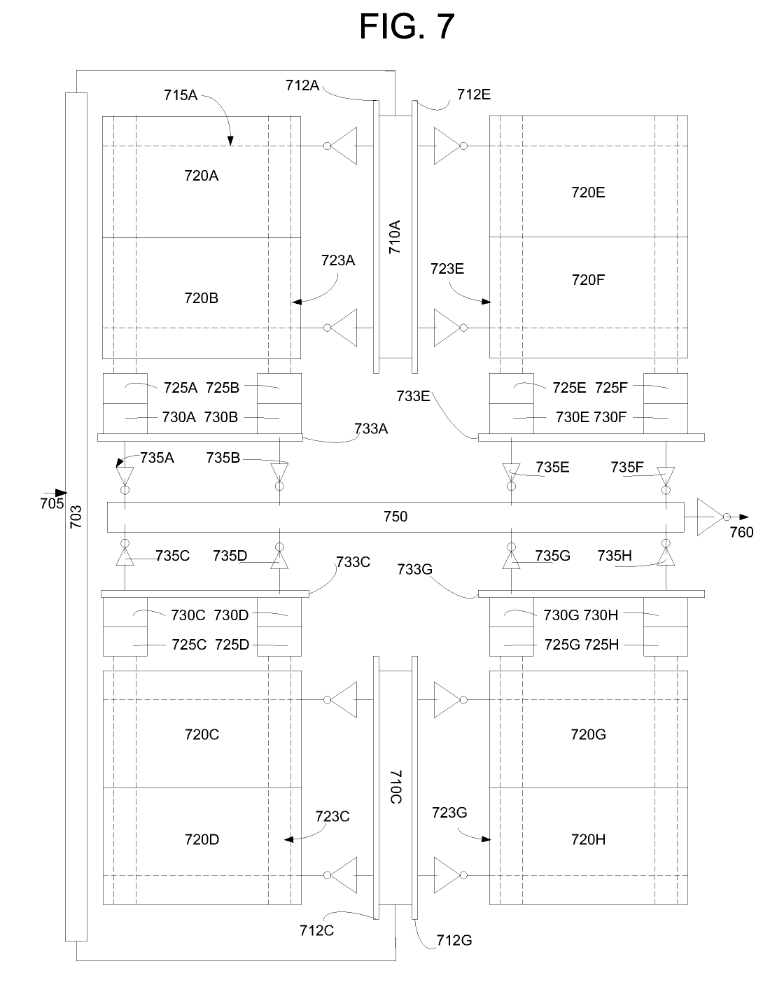

An exemplary embodiment that includes sub-arrays within a memory array is exemplified in FIG. 7. The memory array includes four sub-arrays 723A, 723C, 723E and 723G. The sub-arrays in this example are each made up of two memory modules (sub-array 723A includes first memory module 720A and second memory module 720B; sub-array 723C includes first memory module 720C and second memory module 720D; sub-array 723E includes first memory module 720E and second memory module 720F; and sub-array 723G includes first memory module 720G and second memory module 720H).

The embodiment depicted in FIG. 7 shows a memory array that includes a pre-decoder 703 that receives the address from the host 705. The pre-decoder 703 functions to indicate the particular sub-array within the memory array that should be accessed.

The pre-decoder 703 is configured to communicate with the decoders. This particular exemplary embodiment includes two decoders, a first decoder 710A and a second decoder 710C. Less or more than two decoders can be utilized, and the number of decoders will affect the decoding delay of a single access. The first decoder 710A in this exemplary embodiment is configured to decode addresses for the first sub-array 723A and the third sub-array 723E. The second decoder 710C in this exemplary embodiment is configured to decode the address for the second sub-array 723C and the fourth sub-array 723G. FIG. 7 also illustrates first latches 712A, 712C, 712E and 712G. The first latches control, monitor or both control and monitor initiation of enabling and sensing steps.

Each memory module is accessed in the same fashion, by decoding the address for the module, enabling the wordline (illustrated as 715A with respect to the first memory module 720A), sensing the contents of one or more bits at the decoded address (which is the function of the column multiplexers (725A and 725B; 725C and 725D; 725E and 725F; and 725G and 725H) and the sense amplifiers (730A and 730B; 730C and 730D; 730E and 730F; and 730G and 730H). Second latches 733A, 733C, 733E and 733G are also illustrated in FIG. 7. Second latches control, monitor or both control and monitor completion of enabling and sensing steps. Information from the memory modules is then output via data out multiplexers 735A-735H.

Once the information is output from the memory module (or memory modules) it is then routed through a bank multiplexer 750. The bank multiplexer generally functions to select the desired output from all of the output gathered from the memory modules. The bank multiplexer 750 is configured to communicate with the host for outputting the information from the one or more memory modules. The output from the bank multiplexer is then returned to the host in response to the original request from the host.

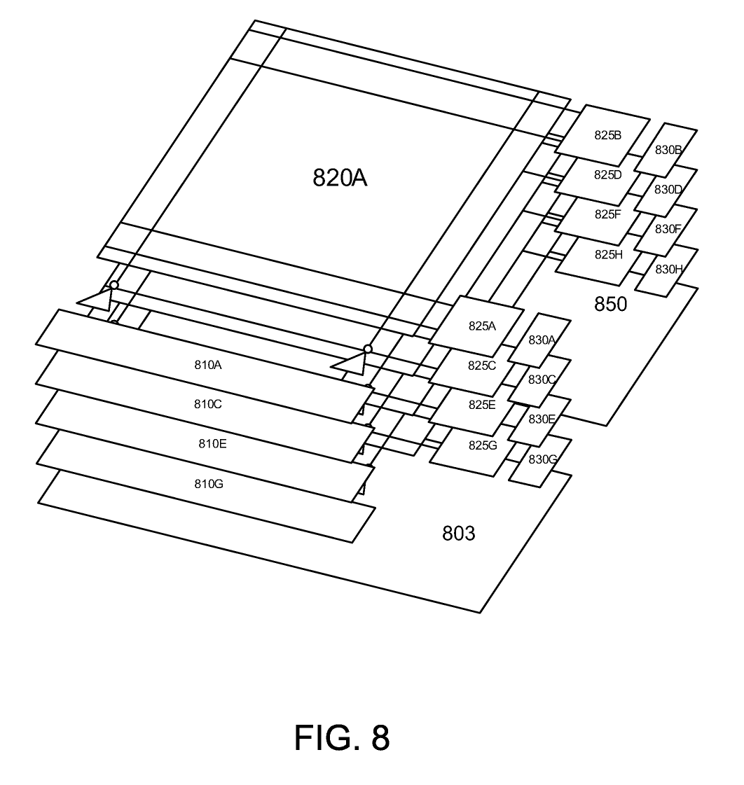

Advantages that can be obtained utilizing memory arrays and methods as disclosed herein can also be extended into a three-dimensional memory array. An exemplary embodiment of a three dimensional memory array can be seen in FIG. 8. The three dimensional memory array depicted in FIG. 8 includes components such as those that have already been discussed with respect to other embodiments. Each tier of the three-dimensional memory array includes a memory module 820A (as well as other memory modules not visible), decoders 810A (also 810C, 810E and 810G), column multiplexers 825A-825H and sense amplifiers 830A-830H. A three-dimensional memory array can also include a pre-decoder 803 and a bank multiplexer 850. The components of a three-dimensional memory array generally function as they did in non three-dimensional memory arrays. Generally, three-dimensional memory arrays have relatively larger enabling and sensing delays that can advantageously be made to be substantially equal to the decoding and outputting delays of the three-dimensional memory array. Three-dimensional memory arrays can also offer a significant advantage in that they can reduce wire delay.

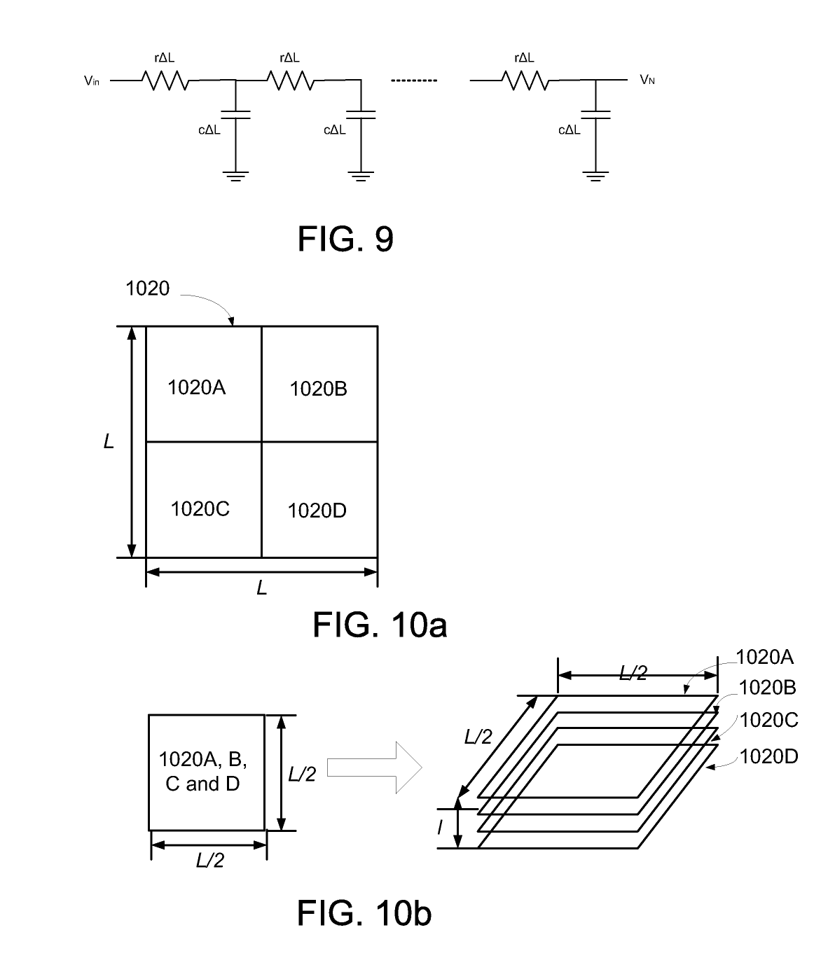

FIG. 9 shows a distributed RC model of interconnect. Here, c and r are the capacitance and resistance per unit length. The wire delay can be determined by using the Elmore delay equation:

$${τ}_{DN} = \sum {C}_{i} {R}_{ij} = {\sum }^{N} {C}_{i} {\sum }^{i} {R}_{j} ∝ {rcL}^{2}$$

As seen in the equation above, the delay of a wire is a quadratic function of its length, L. Because of this, three-dimensional architecture can reduce the wire delay in comparison to non three-dimensional architectures because the length of the wire is effectively reduced. FIG. 10a shows an example of a non three-dimensional array 1020. This exemplary array 1020, has four memory modules 1020A, 1020B, 1020C and 1020D. Each side of the array 1020 has a total length of L, which is proportional to the length of wire that would be involved with accessing the array. Therefore, the wire delay would be proportional to L. When the same array is divided into four memory modules 1020A, 1020B, 1020C and 1020D; and integrated vertically, as exemplified in FIG. 10b, using a three-dimensional technique as discussed herein, the wire length of the new array is half (L/2) of what it was in the non three-dimensional array (L) and the inter-layer distance, l, is negligible compared to the intra-layer distance. Therefore, the same size array will benefit from being three-dimensionally arranged because of the relatively significant delay in wire delay.

Depending on the type of memory that is being utilized in a three-dimensional memory array and the desired size of the three-dimensional memory array, the memory can be partitioned into sub-arrays having particular numbers of modules, with modules having particular sizes. Such partitioning can advantageously lead to substantial equalization of the three stages of memory access, which can allow for the three stages to be carried out simultaneously, thereby effectively reducing the bandwidth of any one access.

Thus, embodiments of pipelined memory access methods and memory architecture therefore are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A method for accessing a memory array, the memory array comprising at least two modules, the method comprising:
receiving an address from a host;
accessing a first module based on the address received from the host, wherein accessing the first module comprises:
decoding the address for the first module;
enabling a wordline based on the decoded address for the first module and sensing the contents of one or more bits at the decoded address for the first module;
and
outputting information regarding the first module; and
accessing a second module based on the address received from the host, wherein accessing the second module comprises:
decoding the address for the second module;
enabling a wordline based on the decoded address for the second module and sensing the contents of one or more bits at the decoded address for the second module; and
outputting information regarding the second module,
wherein the step of decoding the address for the second module occurs while the step of enabling a wordline based on the decoded address for the first module and sensing the contents of one or more bits at the decoded address for the first module occurs.

2. The method according to claim 1, wherein the step of enabling a wordline based on the decoded address for the first module and sensing the contents of one or more bits at the decoded address for the first module does not happen at the same time as the step of enabling a wordline based on the decoded address for the second module and sensing the contents of one or more bits at the decoded address for the second module.

3. The method according to claim 1, wherein the step of outputting information regarding the first module occurs at the same time as the step of enabling a wordline based on the decoded address for the second module and sensing the contents of one or more bits at the decoded address for the second module.

4. The method according to claim 1, wherein only a single enabling and sensing step can occur at one time.

5. The method according to claim 1 further comprising accessing a third module based on the address received from the host, wherein accessing the third module comprises:
decoding the address for the third module;
enabling a wordline based on the decoded address for the third module and sensing the contents of one or more bits at the decoded address for the third module; and
outputting information regarding the third module.

6. The method according to claim 5, wherein the step of enabling a wordline based on the decoded address for the first module and sensing the contents of one or more bits at the decoded address for the first module does not happen at the same time as the step of enabling a wordline based on the decoded address for the second module and sensing the contents of one or more bits at the decoded address for the second module; and the step of enabling a wordline based on the decoded address for the second module and sensing the contents of one or more bits at the decoded address for the second module does not happen at the same time as the step of enabling a wordline based on the decoded address for the third module and sensing the contents of one or more bits at the decoded address for the third module.

7. The method according to claim 5, wherein the step of outputting information regarding the first module; the step of enabling a wordline based on the decoded address for the second module and sensing the contents of one or more bits at the decoded address for the second module; and the step of decoding the address for the third module happen at the same time.

8. The method according to claim 1, wherein each of the at least two modules respectively comprise at least one row of data having at least one bit of data.

9. A memory array comprising:
a first memory module, the first memory module containing at least one row of data having at least one bit of data;
a first latch configured to control initiation of wordline enablement and data sensing from at least the first memory module; and
a second latch configured to control completion of wordline enablement and data sensing from at least the first memory module.

10. The memory array according to claim 9, wherein the memory array comprises MRAM, RRAM, PCM, STTRAM or PMC.

11. The memory array according to claim 9 further comprising a plurality of memory modules.

12. The memory array according to claim 11 further comprising an address decoder.

13. The memory array according to claim 12 further comprising a bank multiplexer to correlate the data sensed from the plurality of memory modules.

14. A method for accessing a memory array, the memory array comprising at least two modules, the method comprising:
receiving an address from a host;
accessing a first module based on the address received from the host, wherein accessing the first module comprises:
decoding the address for the first module;
enabling a wordline based on the decoded address for the first module and sensing the contents of one or more bits at the decoded address for the first module; and
outputting information regarding the first module; and
accessing a second module based on the address received from the host, wherein accessing the second module comprises:
decoding the address for the second module;
enabling a wordline based on the decoded address for the second module and sensing the contents of one or more bits at the decoded address for the second module; and
outputting information regarding the second module,
wherein the step of decoding the address for the second module occurs while the step of enabling a wordline based on the decoded address for the first module and sensing the contents of one or more bits at the decoded address for the first module occurs, and
wherein the number of modules within the memory array and the size of each module are chosen so that the time spent on the decoding step, the enabling and sensing step, and the outputting step are all substantially equal.

15. The method according to claim 14, wherein the step of decoding the address for a module comprises selecting among the at least two modules.

16. The method according to claim 14, wherein the steps of outputting information regarding the first and second module comprises correlating the data sensed from the at least two memory modules.

17. The method according to claim 14, wherein the step of enabling a wordline based on the decoded address for the first module and sensing the contents of one or more bits at the decoded address for the first module does not happen at the same time as the step of enabling a wordline based on the decoded address for the second module and sensing the contents of one or more bits at the decoded address for the second module.

18. The method according to claim 14, wherein the step of outputting information regarding the first module occurs at the same time as the step of enabling a wordline based on the decoded address for the second module and sensing the contents of one or more bits at the decoded address for the second module.

19. The method according to claim 14, wherein only a single enabling step can occur at one time.

20. The method according to claim 14 further comprising accessing a third module based on the address received from the host, wherein accessing the third module comprises:
decoding the address for the third module;
enabling a wordline based on the decoded address for the third module and sensing the contents of one or more bits at the decoded address for the third module; and
outputting information regarding the third module.

21. The method according to claim 20, wherein the step of enabling a wordline based on the decoded address for the first module and sensing the contents of one or more bits at the decoded address for the first module does not happen at the same time as the step of enabling a wordline based on the decoded address for the second module and sensing the contents of one or more bits at the decoded address for the second module; and the step of enabling a wordline based on the decoded address for the second module and sensing the contents of one or more bits at the decoded address for the second module does not happen at the same time as the step of enabling a wordline based on the decoded address for the third module and sensing the contents of one or more bits at the decoded address for the third module.

22. The method according to claim 14, wherein each of the at least two modules respectively comprise at least one row of data having at least one bit of data.
